(19) United States
(12) Patent Application Publication
(10) Pub. No.: US 2009/0110831 A1
(43) Pub. Date: Apr. 30, 2009

(54) METHOD OF SPRAYING A TURBINE ENGINE COMPONENT

(76) Inventors: Frank W. Mase, Kennebunk, ME (US); Christopher W. Strock, Kennebunk, ME (US)

Correspondence Address: CARLSON, GASKEY & OLDS/PRATT & WHITNEY, 400 WEST MAPLE ROAD, SUITE 350, BIRMINGHAM, MI, 48009, US

(21) Appl. No.: 11/877,849

(22) Filed: Oct. 24, 2007

(51) Int. Cl. B05D 1/32

(52) U.S. Cl. 427/282; 118/504

(57) ABSTRACT

A method of spraying a component involves disposing a component near a spray coating device. The component has a first mating feature that is formed as part of the component. A first mask is disposed over a portion of the component and has a second mating feature. The first mating feature is resiliently connected to the second mating feature. The component is then sprayed.

### BACKGROUND OF THE INVENTION

This invention relates to a method of spray coating a component, such as a case for a turbine engine.

As part of the manufacture, repair and maintenance of a turbine engine, it may become necessary to coat a turbine engine component. This process may involve masking portions of the turbine engine component to prevent them from being coated by a spray coating device, such as a thermal spray torch. In addition, masking may protect against grit blast used to prepare the surface of a turbine engine component for coating.

Generally, a metal mask may be used to protect the turbine engine component from the coating. The mask is attached to the turbine engine component by another device. Following coating, the metal mask is removed and then cleaned by chemicals, mechanical techniques or water pressure. This masking process is very expensive because of material and labor costs associated with the mask and its cleaning.

Another alternative is to use a tape mask. Portions of the turbine engine component are manually covered with tape. This process, however, is labor intensive.

A need therefore exists for a technique for protecting a turbine engine component from a spray, such as from a thermal spray torch, that is easy to install and is inexpensive.

### SUMMARY OF THE INVENTION

The invention comprises a method of spraying a component. A turbine engine component, such as a case, is disposed near a spray coating device, such as a thermal spray torch. The turbine engine component has a first mating feature formed as part of the turbine engine component. A mask is disposed over a portion of the turbine engine component. The mask has a second mating feature. The mask is connected to the turbine engine component by resiliently connecting the first mating feature to the second mating feature. The turbine engine component is then sprayed.

The various features and advantages of this invention will become apparent to those skilled in the art from the following detailed description. The drawings that accompany the detailed description can be briefly described as follows.

### BRIEF DESCRIPTION OF THE DRAWINGS

FIG. 1 illustrates a cross sectional view of a turbine engine component and a mask prior to the resilient connection of the mask to the turbine engine component.

FIG. 2 illustrates the resilient connection of the mask of FIG. 1 to the turbine engine component.

FIG. 3 illustrates a side view of the turbine engine component with mask in place sprayed by a thermal spray coating device.

FIG. 4 illustrates a plan view of the turbine engine component, mask and thermal spray coating device of FIGS. 1 through 3.

### DETAILED DESCRIPTION OF THE PREFERRED EMBODIMENT

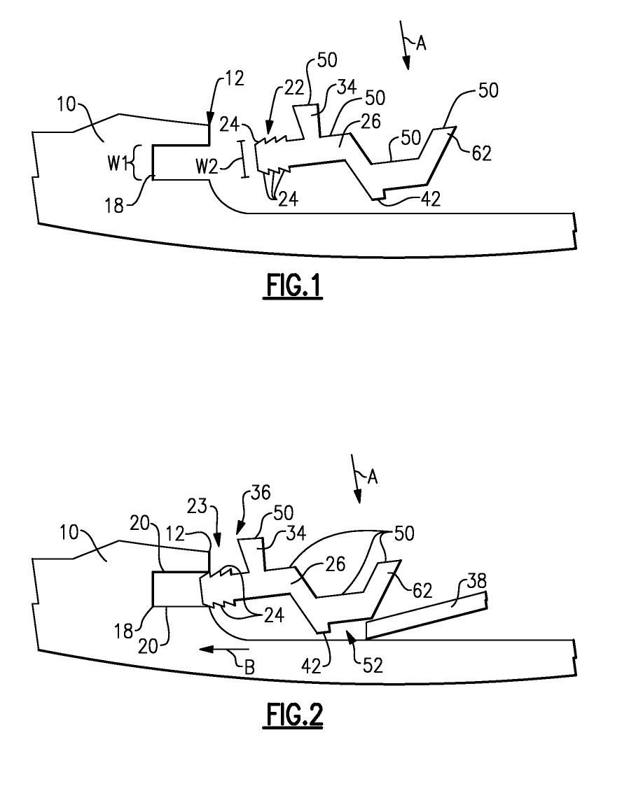

FIG. 1 illustrates a cross sectional view of the inventive mask, first mask 26, and turbine engine component 10, such as a case for a turbine engine. Turbine engine component 10 has first mating feature 18, which is formed integrally with turbine engine component 10. Here, first mating feature 18 is a slot for receiving a turbine vane or other airfoil component. First mating feature 18 has width W₁. First mating feature 18 may be an opening as well.

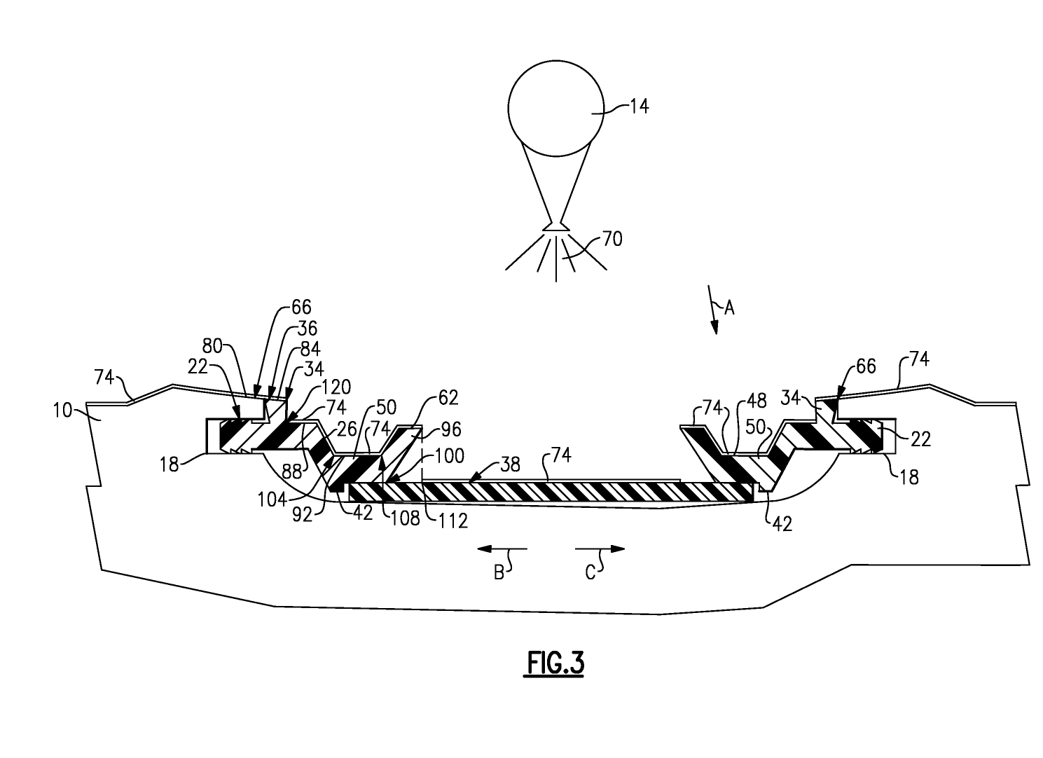

First mask 26 is made of a resilient material, such as rubber, and has lands 50 that serve to block the application of coating on turbine engine 10, say in the direction of arrow A. First mask 26 has second mating feature 22, here a barbed protrusion with ribs 24 having outer width W₂. Width W₂ is slightly greater than width W₁ such that when first mask 26 is inserted into the direction of arrow B, as shown in FIG. 2, into first mating feature 18, ribs 24 compress inwardly as they are pressed into first mating feature 18. Because first mask 26 and, in particular, second mating feature 22 are made of resilient material, second mating feature 22 will resiliently connect with first mating feature 18 as ribs 24 rebound outwardly against walls 20 of first mating feature 18. First mask 26 is thereby held in place to first mating feature 18 of turbine engine component 10 by second mating feature 22. In this way, first mask 26 may be quickly and easily installed into an existing feature of the turbine engine component 10. No additional connection device is required.

With reference to FIG. 1, first mask 26 has first flange 34, second flange 62 and support 42. First flange 34 is also resilient and compressible because it is likewise made of rubber or other resilient material. When first mask 26 is seated in first mating feature 18 as shown in FIG. 3, corner 34 of first flange 36 will compress against edge 12 of turbine engine component 10 to thereby form seal 66 against coating in the direction of arrow A (as shown in FIG. 3). Coating is thereby prevented from passing into first mating feature 18 as well as the surrounding area. Thus, in one insertion of first mask 26 in the direction of arrow B, first mask 26 is both connected to turbine engine component 10 and seal 66 is formed.

In addition, first mask 26 may be used in conjunction with another mask, say second mask 38, which may be made of inexpensive metal, plastic or rubber sheet stock. As shown in FIG. 2, first mask 26 is inserted in the direction of arrow B and second mask 38 is then disposed in the same direction under first mask 26 at location 52. With reference to FIG. 2, first mask 26 has support 42 that secures second mask 38 from further movement in the direction of arrow B. Furthermore, support 42 also precludes or blocks movement of overspray from spray coating device 14, such as from a thermal spray torch, that may pass in the direction of arrow B along second mask 38.

With reference to FIG. 3, third mask 48, having the same features as first mask 26 as shown, is disposed over second mask 38 and is also resiliently connected to turbine engine component 10 in the same manner as first mask 26 into first mating feature 18. Third mask 48 has support 42 to prevent movement of second mask 38 in the direction of arrow C. In this way, second mask 38 may be quickly secured to turbine engine component 10.

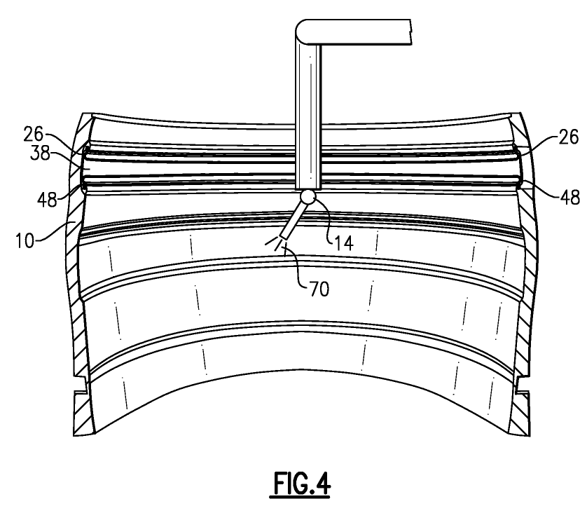

Referring back to FIG. 3, once first mask 26, second mask 38 and third mask 48 are secured to turbine engine component 10, spray coating device 14 expels spray 70 in the direction of arrow A. Turbine engine component 10 is thereby protected against coating in the areas covered by first mask 26, second mask 38 and third mask 48. As shown in FIG. 4, large portions of turbine engine component 10 may be protected from coating sprayer 14 by quickly inserting first mask 26, second mask 38 and third mask 48.

Moreover, as shown in FIG. 3, surfaces 84, 88, 92 and 96 are stepped in the direction of arrow A relative to first surface 80. Surface 88 is displaced from surface 80 while surface 92 is displaced from surface 88. Surface 96 is also displaced from its neighboring surface, surface 92, as well as surface 100 of second mask 38. Consequently, when spray coating device 14 sprays in the direction of arrow A, coating 74 is formed at different levels creating break lines for the coating at locations 120, 104, 108 and 112. Because coating 74 is broken at these locations, coating 74 may be easily removed by peeling along the break lines. In this way, excess coating may be quickly removed from first mask 26, second mask 38 and third mask 48 as well as ultimately from turbine engine component 10.

The foregoing description shall be interpreted as illustrative and not in any limiting sense. A worker of ordinary skill in the art would recognize that certain modifications would come within the scope of this invention. For that reason, the follow claims should be studied to determine the true scope and content of this invention.

We claim:

1. A method of spraying a component, comprising the steps of:
a) disposing a turbine engine component proximate a spray coating device, the component having a first mating feature formed as part of the component;
b) disposing a first mask over a portion of the component, the mask having a second mating feature;
c) resiliently connecting the first mating feature to the second mating feature; and
d) spraying the component.

2. The method of claim 1, including the step of:
e) compressing a portion of the first mask against a surface of the component to form a seal.

3. The method of claim 1, including the step of:
f) disposing a second mask between the first mask and the component so that the second mask is secured by the first mask against the component.

4. The method of claim 3 wherein the first mask has a support to retain the second mask.

5. The method of claim 4 wherein the support is configured to block a spray from the spray coating device.

6. The method of claim 1 wherein one of the first mating feature and the second mating feature forms an opening and the other of the first mating feature and the second mating feature forms a protrusion disposable in the opening.

7. The method of claim 6 wherein the protrusion has a compressible rib for securing the protrusion to the opening.

8. The method of claim 7 wherein resiliently connecting comprises inserting the protrusion into the hole.

9. The method of claim 1 wherein the first feature is a slot for receiving an air foil component of a turbine engine component.

10. The method of claim 1 wherein the first mask has a first surface and has a second surface, the second surface spaced from the first surface along a direction of spray from the sprayer such that a break is created in the spray between the first surface and the second surface.

11. A method of coating a turbine engine component, comprising the steps of:
a) disposing a turbine engine component proximate a spray coating device, the turbine engine component having a first mating feature formed as part of the turbine engine component;
b) disposing a first mask over a portion of the turbine engine component, the mask having a second mating feature;
c) resiliently connecting the first mating feature to the second mating feature;
d) compressing a portion of the first mask against a surface of the turbine engine component to form a seal against the coating; and
e) coating the turbine engine component.

12. The method of claim 11, including the step of:
f) disposing a second mask between the first mask and the turbine engine component so that the second mask is secured by the first mask against the turbine engine component.

13. The method of claim 12 including a third masking resiliently secured to the turbine engine component and securing the second mask against the turbine engine component.

14. The method of claim 10 wherein the first mask has a block that supports the second mask.

15. The method of claim 14 wherein the block blocks a spray from the spray coating device.

16. The method of claim 11 wherein one of the first mating connector and the second mating connector forms a hole and the other of the first mating connector and the second mating connector forms a protrusion disposable in the hole.

17. The method of claim 16 wherein the protrusion has a compressible rib for securing the protrusion to the hole.

18. The method of claim 11 wherein the first feature is a slot for receiving an air foil component of the turbine engine component.

19. The method of claim 11 wherein the first mask component has a first surface and has a second surface, the second surface spaced from the first surface along a direction of spray from the spray coating device such that break is created in the coating between the first surface and the second surface when the turbine engine component is sprayed.

20. A coating mask for a turbine engine component, comprising:
a land for blocking a spray coating;
said land having a first mating feature for connecting said land to a turbine engine component;
a sealing protrusion extending from said land, said sealing protrusion for engagement with a surface of the turbine engine component; and
wherein said first mating feature is resiliently connectable to a second mating feature of the turbine engine component.
